(19) United States
(12) Patent Application Publication
(10) Pub. No.: US 2026/0241873 A1
(43) Pub. Date: Aug. 20, 2026

(54) GARNISH ASSEMBLY FOR EXTERIOR VEHICLE CAMERA OR SENSOR

(71) Applicant: Honda Motor Co., Ltd., Tokyo (JP)

(72) Inventors: Connor ISINGS, Columbus, OH (US); Timothy J. Rupp, Dublin, OH (US)

(21) Appl. No.: 19/056,021

(22) Filed: Feb. 18, 2025

(51) Int. Cl. B60R 11/04; B60R 11/00; B60R 13/04; B60R 13/06

(52) U.S. Cl. CPC B60R 11/04; B60R 13/04; B60R 13/06; B60R 2011/004; B60R 2011/0043

(57) ABSTRACT

A garnish assembly for a vehicle, the vehicle including a body panel, and the vehicle defining an interior cabin. The garnish assembly includes an outer garnish panel having an inner surface and an outer surface and an outer gasket disposed on the inner surface of the outer garnish panel. A bracket configured for mounting an electronic device is secured to the inner surface of the outer garnish panel, with the outer gasket disposed between the outer garnish panel and the bracket. An inner gasket having a peripheral edge is disposed adjacent the inner surface of the outer garnish panel. The inner gasket and the outer gasket are sealingly engaged to prevent any water intrusion into the interior cabin of the vehicle.

### BACKGROUND

### 1. Field of the Disclosure

The present disclosure relates to a garnish assembly and, more particularly, to a garnish assembly on an exterior vehicle panel for mounting a camera or sensor assembly.

### 2. Description of Related Art

Many automobiles and other motorized vehicles include panels that enhance the appearance and/or functionality of the vehicle body, including those that are configured to mount a camera used for viewing at least a part of the surroundings of a vehicle. These panels are referred to as garnish panels or simply a “garnish.” Garnish panels for cameras are often placed within the body panels, for example on the side and/or rear panels of the vehicle to provide the driver with enhanced viewing on the side areas and/or behind the vehicle.

In current vehicles, external camera garnish assemblies are typically disposed in areas of the vehicle that have a “wet zone” on the inner surface. This allows for any water that may enter through the garnish and camera lens opening to drain so there is little concern for corrosion or intrusion into the interior cabin. More particularly, with reference to FIGS. 1 and 2, a vehicle 10 includes a body panel 12 having an opening 14 for a camera or sensor bracket 16. The camera bracket 16 with a camera 18 mounted thereon extends through the opening 14 and a garnish 20 surrounds the camera lens 26 and secures the camera 18 to the body panel 12. A garnish seal 22 is disposed between the body panel 12 and the garnish 20 to prevent water intrusion into the interior of the vehicle 10. As a further defense against water intrusion, the opening 14 between the bracket and the body panel allows water to drain along a path W into a predetermined “wet zone” of the vehicle such that it will exit without entering the interior cabin.

This type of garnish has proven effective but a wet zone is required in order to mount the camera, and thus limits the locations on the vehicle where cameras can be utilized. This will become even more problematic as self-driving vehicle features become more prominent in the market. Accordingly, there is a need in the art for an improved camera garnish assembly that is not limited to use in the predetermined wet zones of a vehicle.

### SUMMARY

The disclosure herein is directed to a vehicle garnish assembly that allows a camera or sensor or other electronic device to be safely mounted in an area other than a wet zone of a vehicle without concern for water intrusion into the main passenger compartment of the vehicle. This increases the flexibility for placement of cameras or sensors and thus improves the overall safety of the vehicle.

In one aspect, the disclosure provides a vehicle having a vehicle body with an opening, the vehicle body defining a passenger cabin therewithin; a bracket configured for mounting an electronic device, the bracket configured to be received within the opening of the vehicle body; an outer garnish panel having an inner surface and an outer surface, the outer garnish panel configured to be mounted over the opening on the vehicle body, the bracket being secured to the inner surface of the outer garnish panel; an outer gasket disposed between the inner surface of the outer garnish panel and the bracket; and an inner gasket disposed between the inner surface of the outer garnish panel and the vehicle body. The inner gasket and said outer gasket encapsulate the bracket to prevent any water intrusion through the opening in the vehicle body from reaching the passenger cabin of the vehicle.

In another aspect, the disclosure is directed to a garnish for a camera or sensor on a vehicle. The garnish includes an outer garnish panel having an exterior surface and an interior surface; an outer gasket disposed along the interior surface of the outer garnish panel; and an inner gasket having a peripheral edge secured to the interior surface of the outer garnish panel; wherein the inner gasket and outer gasket define an interior chamber configured to receive the camera or sensor.

A further aspect of the disclosure is directed to a garnish assembly for a vehicle, the vehicle including a body panel, and the vehicle defining an interior cabin. The garnish assembly includes an outer garnish panel having an inner surface and an outer surface; an outer gasket disposed on the inner surface of the outer garnish panel; a bracket configured for mounting an electronic device secured to the inner surface of the outer garnish panel, the outer gasket disposed between the outer garnish panel and the bracket; and an inner gasket having a peripheral edge disposed adjacent the inner surface of the outer garnish panel. The inner gasket and the outer gasket are sealingly engaged to prevent any water intrusion into the interior cabin of the vehicle.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a schematic side view of a portion of a vehicle generally illustrating an exterior camera/sensor garnish assembly and adjacent vehicle panels.

FIG. 2 is a schematic cross section taken generally along line A-A in FIG. 1 of a camera/sensor garnish assembly, according to the prior art.

FIG. 3 is a schematic cross-section taken generally along line A-A in FIG. 1 of a camera/sensor garnish assembly according to an exemplary embodiment of the disclosure.

FIG. 3A is an enlarged view of detail portion 3A shown in FIG. 3.

FIG. 3B is an enlarged view of detail portion 3B shown in FIG. 3.

FIG. 3C is an enlarged view of detail portion 3C shown in FIG. 3.

FIG. 3D is an enlarged view of detail portion 3D shown in FIG. 3.

FIG. 3E is an enlarged view of detail portion 3E shown in FIG. 3.

### DETAILED DESCRIPTION

The disclosure herein is directed to a vehicle including a vehicle body defining a structural periphery of the vehicle. As shown in the accompanying figures and discussed in greater detail below, the vehicle includes a garnish panel for an electronic device configured to be mounted on the vehicle body. The garnish panel allows an electronic device to be safely mounted in an area other than a wet zone of a vehicle without concern for water intrusion into the main passenger compartment of the vehicle. This increases the flexibility for placement of cameras or sensors and thus improves the overall safety of the vehicle.

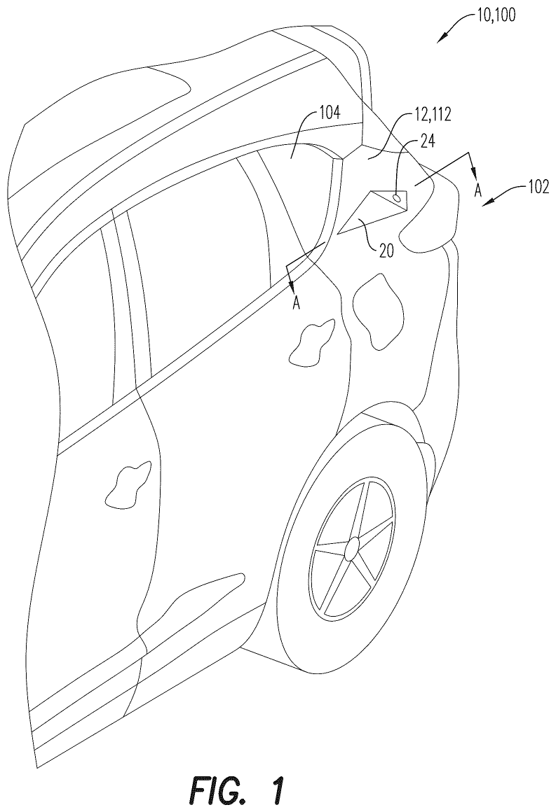

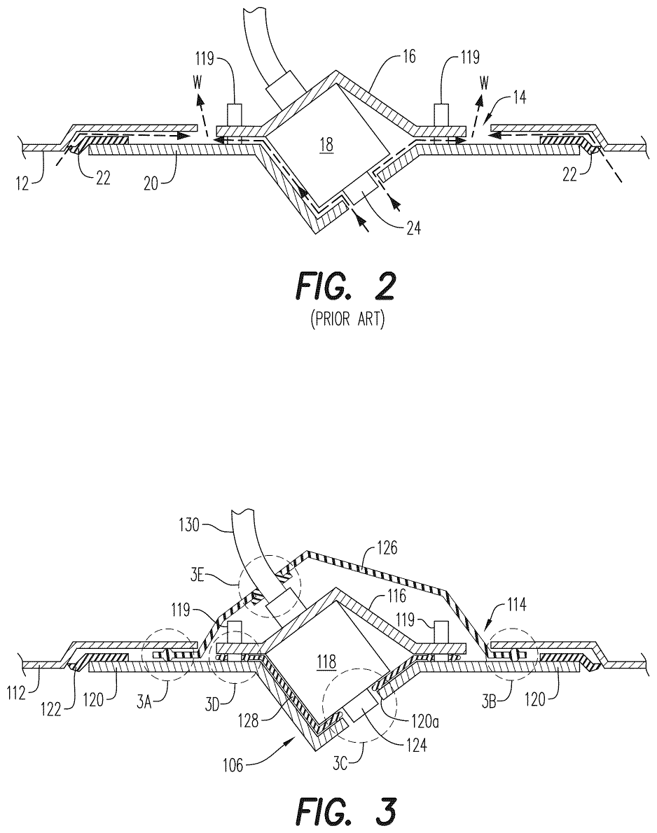

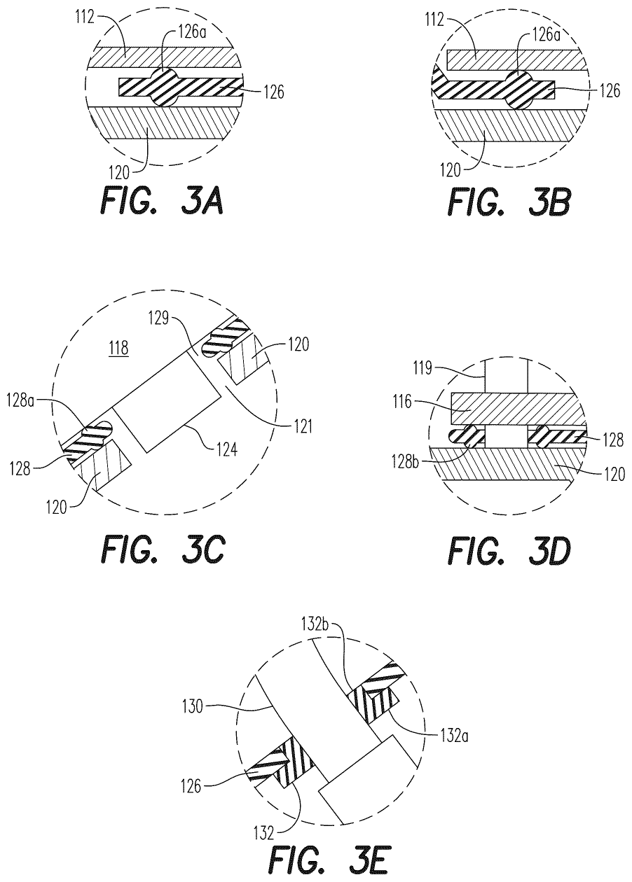

Referring to FIGS. 1 and 3, a vehicle including a garnish assembly is shown generally by reference numeral 100. Vehicle 100 includes a rear end 102, an opposing forward end (not shown), a rear quarter panel window 104, and a body panel 112 located proximate the rear quarter panel window 104.

As illustrated in the cross section of FIG. 3, body panel 112 includes an opening 114 for receiving a garnish assembly 106 including a bracket 116 for an electronic device such as a camera, sensor or any other type of device known in the art. The bracket 116 with a camera body 118 mounted thereon in the exemplary embodiment extends through the opening 114 and an outer garnish panel 120 is configured to surround the camera lens 124 such that the camera lens has a clear view of the exterior area around the vehicle. The bracket 116 and outer garnish panel 120 are connected by fasteners 119, such as bolts, screws, and the like, to secure together the camera bracket 116 and the outer garnish panel 120.

In an exemplary embodiment of the disclosure, the garnish assembly 106 further includes an outer gasket 128 disposed between the camera body 118 and the outer garnish 120 so as to inhibit water intrusion around the opening 121 in the outer garnish 120 for the protruding camera lens 124. With reference also to FIG. 3C, in an exemplary embodiment of the disclosure, the outer gasket 128 also includes an opening 129 for the camera lens 124 to extend therethrough and the edge near the opening 129 includes a sealing rib 128a. As illustrated best in FIG. 3C, the sealing rib 128a has a greater thickness than the thickness of the outer garnish 120. Thus, the sealing rib 128a forms an annular seal for sealing together the outer garnish 120 and the camera 118, thereby protecting the camera 118 from water entry through the lens opening in the outer garnish 120.

In an exemplary embodiment of the disclosure, the outer gasket 128 also has openings for the fasteners 119 used to connect the outer garnish 120 to the camera bracket 116. The edges of the opening in the outer gasket 128 for the fasteners 119 may also include a sealing rib 128b, as shown in FIG. 3D, the sealing rib 128b has a greater thickness than the thickness of the outer gasket 128.

The outer gasket 128 is formed from a polyethylene foam in the exemplary embodiment of the disclosure, but other compressible materials known in the art could of course also be used such as an ethylene propylene diene monomer (EPDM) sponge for example.

At the outer peripheral edge of the garnish 120, a garnish seal 122 is disposed between the body panel 112 and the garnish 120 to prevent water intrusion into the interior of the vehicle 100, as discussed above relative to the prior art. In addition, however, an exemplary embodiment of the disclosure further provides an inner gasket 126 between the body panel 112 and the outer garnish 120 which is disposed inward toward the camera 118 from the garnish seal 122. As shown in FIGS. 3A and 3B, the peripheral edge of the inner gasket 126 includes a sealing rib 126a, 126b having a thickness greater than that of the inner gasket 126 for compressibly sealing together the body panel 112 and the outer garnish 120. The inner gasket 126 extends through the opening 114 in the body panel 112 to substantially encapsulate the camera bracket 116 and camera 118. The inner gasket 126 further includes an opening to allow a cord 130, such as a power cord and/or data cable, to pass out of the encapsulated area and into the vehicle 100. As shown in FIG. 3E, an insert 132 formed from rubber or other similar material tightly surrounds the cord 130. The insert 132 is defined by a first cylindrical body 132a overlapping an interior surface of the inner gasket 126 and a second cylindrical body 132b that entirely fills the opening in the inner gasket 126. The second cylindrical body 132b has a smaller diameter than the first cylindrical body 132a, as shown in FIG. 3E, in order to tightly seal against the cord 130. The insert 132 thus prevents any further water ingress that might have made it past the outer garnish side seals 122.

These combined features of the garnish assembly 106 together create a multi-level sealing environment that is needed to ensure no water enters the main cabin of the vehicle. The garnish assembly 106 is thus suitable for application to a location on a vehicle other than wet zones as in previous vehicles. That is, multi-level sealing features of the garnish assembly 106 allow the installation of cameras and/or sensors where a dry zone is required on the interior of the main vehicle cabin.

While various embodiments of the disclosure have been described, the description is intended to be exemplary, rather than limiting and it will be apparent to those of ordinary skill in the art that many more embodiments and implementations are possible that are within the scope of the disclosure. Although many possible combinations of features are shown in the accompanying figures and discussed in this detailed description, many other combinations of the disclosed features are possible. Any feature of any embodiment may be used in combination with, or substituted for, any other feature or element in any other embodiment unless specifically restricted. Therefore, it will be understood that any of the features shown and/or discussed in the present disclosure may be implemented together in any suitable combination. Accordingly, the disclosure is not to be restricted except in light of the attached claims and their equivalents. Also, various modifications and changes may be made within the scope of the attached claims.

We claim:

1. A vehicle comprising:
a vehicle body having an opening, the vehicle body defining a passenger cabin therewithin;
a bracket configured for mounting an electronic device, the bracket configured to be received within the opening of the vehicle body;
an outer garnish panel having an inner surface and an outer surface, the outer garnish panel configured to be mounted over the opening on the vehicle body, the bracket being secured to the inner surface of the outer garnish panel;
an outer gasket disposed between the inner surface of the outer garnish panel and the bracket; and
an inner gasket disposed between the inner surface of the outer garnish panel and the vehicle body;
wherein the inner gasket and said outer gasket encapsulate the bracket to prevent any water intrusion through the opening in the vehicle body from reaching the passenger cabin of the vehicle.

2. The vehicle according to claim 1, further comprising an outer garnish seal disposed between the outer garnish panel and the vehicle body.

3. The vehicle according to claim 1, wherein the outer garnish panel includes an opening configured for a protruding portion of the electronic device.

4. The vehicle according to claim 3, wherein the outer gasket includes an opening configured for the protruding portion of the electronic device, the outer gasket preventing water intrusion through the opening in the outer garnish panel.

5. The vehicle according to claim 4, wherein the outer gasket includes a sealing rib, the sealing rib having a greater diameter than a diameter of the outer gasket.

6. The vehicle according to claim 1, wherein the inner gasket includes an opening configured for a cord attached to the electronic device to pass therethrough.

7. The vehicle according to claim 6, further comprising an insert disposed within the opening of the inner gasket and configured to be tightly sealed around the cord attached to the electronic device, the insert preventing water intrusion through the opening in the inner gasket.

8. The vehicle according to claim 7, wherein the insert includes a first cylindrical body having a first diameter and a second cylindrical body having a second diameter, the first diameter being greater than the second diameter.

9. A garnish for a camera or sensor on a vehicle comprising:
an outer garnish panel having an exterior surface and an interior surface;
an outer gasket disposed along the interior surface of the outer garnish panel; and
an inner gasket having a peripheral edge secured to the interior surface of the outer garnish panel;
wherein the inner gasket and outer gasket define an interior chamber configured to receive the camera or sensor.

10. The garnish according to claim 9, wherein the outer garnish panel includes an opening and the outer gasket includes an opening generally corresponding in diameter to the opening in the outer garnish panel.

11. The garnish according to claim 10, wherein the inner gasket includes an opening.

12. The garnish according to claim 11, further comprising an insert configured to be inserted into the opening of the inner gasket.

13. The garnish according to claim 12, wherein the insert includes a first cylindrical body having a first diameter and a second cylindrical body having a second diameter, the first diameter being greater than the second diameter.

14. A garnish assembly for a vehicle, the vehicle including a body panel, and the vehicle defining an interior cabin, the garnish assembly comprising:
an outer garnish panel having an inner surface and an outer surface;
an outer gasket disposed on the inner surface of the outer garnish panel;
a bracket configured for mounting an electronic device secured to the inner surface of the outer garnish panel, the outer gasket disposed between the outer garnish panel and the bracket; and
an inner gasket having a peripheral edge disposed adjacent the inner surface of the outer garnish panel;
wherein the inner gasket and the outer gasket are sealingly engaged to prevent any water intrusion into the interior cabin of the vehicle.

15. The garnish assembly according to claim 14, wherein the outer garnish panel includes an opening configured for a protruding portion of the electronic device.

16. The garnish assembly according to claim 15, wherein the electronic device is a camera and the protruding portion is the camera lens.

17. The garnish assembly according to claim 15, wherein the outer gasket includes an opening configured for the protruding portion of the electronic device.

18. The garnish assembly according to claim 17, wherein the outer gasket further includes a sealing rib, the sealing rib having a greater diameter than a diameter of the outer gasket so as to prevent water intrusion through the opening in the outer garnish panel.

19. The garnish assembly according to claim 17, wherein the inner gasket includes an opening configured for receiving a cord of the electronic device passing therethrough.

20. The garnish assembly according to claim 19, wherein the inner gasket further includes an insert disposed within the opening of the inner gasket and configured to be tightly sealed around the cord of the electronic device, the insert preventing water intrusion through the opening in the inner gasket.
